(19) United States
(12) Patent Application Publication
(10) Pub. No.: US 2023/0389135 A1
(43) Pub. Date: Nov. 30, 2023

(54) COOKTOP APPLIANCE AND METHOD FOR DETECTING COOKWARE REMOVAL

(71) Applicant: Haier US Appliance Solutions, Inc., Wilmington, DE (US)

(72) Inventor: Omar Santana, Louisville, KY (US)

(21) Appl. No.: 17/824,166

(22) Filed: May 25, 2022

(51) Int. Cl. H05B 3/74

(52) U.S. Cl. CPC H05B 3/74; H05B 2213/05

(57) ABSTRACT

A controller and cooktop appliance configured to execute steps of a method for operating the cooktop appliance are provided. The method includes detecting a temperature drop of a threshold magnitude during an observation period; allowing for temperature decrease during a waiting period; obtaining a rolling difference in temperature during a calculation period; and determining, from the rolling difference in temperature, whether cookware is removed based on a comparison of a quantity of differences above a temperature magnitude to a quantity of differences below the temperature magnitude.

### FIELD OF THE INVENTION

The present subject matter relates generally to cooktop appliances, such as radiant or induction cooktop appliances, and systems for controlling heating by the cooktop appliances.

### BACKGROUND OF THE INVENTION

Certain cooktop appliances include heating elements for heating cookware, such as pots and pans. The heating elements can be operated at various settings, such as ranging from a low heat (e.g., for simmering food) to a high heat (e.g., for boiling or searing). When users cook on a cooktop appliance, they may remove the cookware from the active heating element without turning the heating element off. This may result in wasted energy and producing an exposed hot surface, which may create safety hazards.

For radiant heating elements particularly, the resistive properties of the heating element may not allow for monitoring the presence of cookware through monitoring current or voltage. Furthermore, utilizing additional sensors or imaging devices to detect the presence or absence of cookware may add undesired complexity and cost to the cooktop appliance.

Accordingly, a cooktop appliance and a method for operation to determine the presence or absence of cookware would be useful.

### BRIEF DESCRIPTION OF THE INVENTION

An aspect of the present subject matter is directed to a computer-implemented method for controlling a heating assembly of a cooktop appliance. The method includes detecting a temperature drop of a threshold magnitude during an observation period; allowing for temperature decrease during a waiting period; obtaining a rolling difference in temperature during a calculation period; and determining, from the rolling difference in temperature, whether cookware is removed based on a comparison of a quantity of differences above a temperature magnitude to a quantity of differences below the temperature magnitude.

Another aspect of the present disclosure is directed to a cooktop appliance. The cooktop appliance includes a heating assembly and a controller in operative communication with the heating assembly. The controller is configured to detect a temperature drop of a threshold magnitude within a first period of time; after a second period of time from detection of the temperature drop of the threshold magnitude, obtain a temperature signal during a third period of time; obtain a rolling difference in temperature over a fourth period of time following the third period of time; and determine, from the rolling difference in temperature, whether cookware is removed based on a comparison of a quantity of differences above a temperature magnitude to a quantity of differences below the temperature magnitude.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a top, plan view of a cooktop appliance according to an exemplary embodiment of the present subject matter.

FIG. 2 provides a top, plan view of a heating assembly of the exemplary cooktop appliance of FIG. 1.

FIG. 3 provides a schematic view of certain components of the exemplary cooktop appliance of FIG. 1 including exemplary cookware at a heating assembly of the cooktop appliance.

FIG. 4 provides a flowchart outlining exemplary steps of a method for controlling a heating element of a cooktop appliance according to an exemplary embodiment of the present subject matter.

FIG. 5 provides a graph depicting an exemplary operation of the method outlined in FIG. 4 in accordance with an exemplary embodiment of the present subject matter.

FIG. 6 provides a graph depicting an exemplary operation of the method outlined in FIG. 4 in accordance with an exemplary embodiment of the present subject matter.

FIG. 7 provides a graph depicting an exemplary operation of the method outlined in FIG. 4 in accordance with an exemplary embodiment of the present subject matter.

FIG. 8 provides a graph depicting an exemplary operation of the method outlined in FIG. 4 in accordance with an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

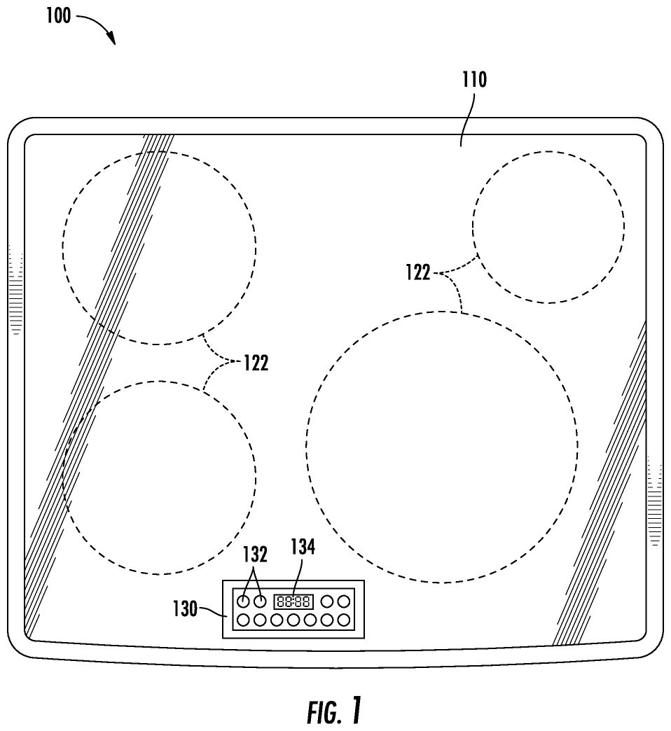

FIG. 1 provides a top, plan view of a cooktop appliance 100 according to an exemplary embodiment of the present subject matter. Cooktop appliance 100 can be installed in various locations such as in cabinetry in a kitchen, with one or more ovens to form a range appliance, or as a standalone appliance. Thus, as used herein, the term “cooktop appliance” includes grill appliances, stove appliances, range appliances, and other appliances that incorporate cooktops.

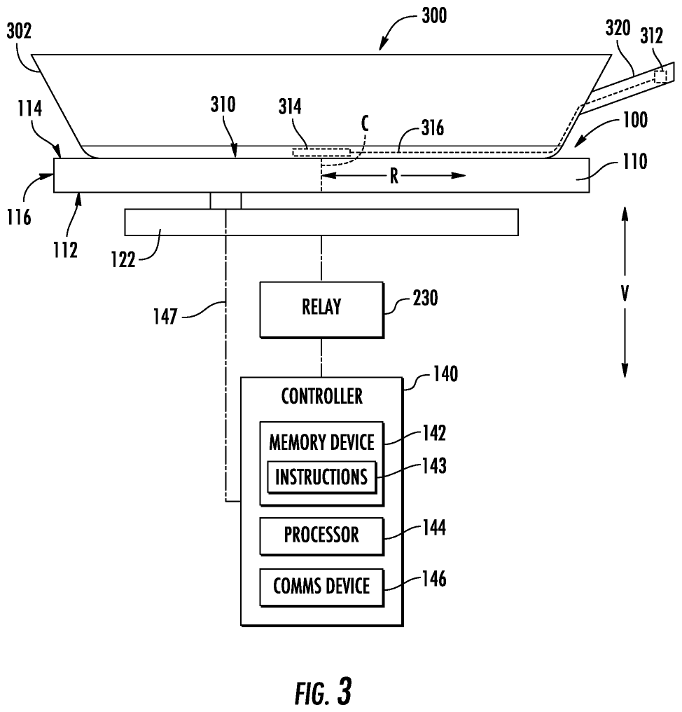

Cooktop appliance 100 includes a ceramic plate 110 for supporting cooking utensils, such as pots or pans, on a cooking or top surface 114 (FIG. 3) of ceramic plate 110. Ceramic plate 110 may be any suitable ceramic or glass plate. Radiant heating assemblies 122 are mounted below ceramic plate 110 such that heating assemblies 122 are positioned below ceramic plate 110, e.g., along a vertical direction V (FIG. 3). Ceramic plate 110 may be continuous over heating assemblies 122.

While shown with four heating assemblies 122 in the exemplary embodiment of FIG. 1, cooktop appliance 100 may include any number of heating assemblies 122 in alternative exemplary embodiments. Heating assemblies 122 can also have various diameters. For example, each heating assembly of heating assemblies 122 can have a different diameter, the same diameter, or any suitable combination thereof. Certain heating assemblies 122 may include a single radiant heating element or zone. Conversely, other heating assemblies 122 may include two or more radiant heating elements or zones. However, cooktop appliance 100 is provided by way of example only and is not limited to the exemplary embodiment shown in FIG. 1. For example, a cooktop appliance having one or more radiant heating assemblies in combination with one or more electric resistance or gas burner heating elements can be provided. In addition, various combinations of number of heating assemblies, position of heating assemblies and/or size of heating assemblies can be provided.

A user interface 130 provides visual information to a user and allows a user to select various options for the operation of cooktop appliance 100. For example, displayed options can include a desired heating assembly 122, a desired cooking temperature, and/or other options. User interface 130 can be any type of input device and can have any configuration. In FIG. 1, user interface 130 is located within a portion of ceramic plate 110. Alternatively, user interface 130 can be positioned on a vertical surface near a front side of cooktop appliance 100 or anywhere convenient for a user to access during operation of cooktop appliance 100.

In the exemplary embodiment shown in FIG. 1, user interface 130 includes a capacitive touch screen input device component 132. Capacitive touch screen input device component 132 can allow for the selective activation, adjustment or control of any or all heating assemblies 122 as well as any timer features or other user adjustable inputs. One or more of a variety of electrical, mechanical or electro-mechanical input devices including rotary dials, push buttons, toggle/rocker switches, and/or touch pads can also be used singularly or in combination with capacitive touch screen input device component 132. User interface 130 also includes a display component 134, such as a digital or analog display device designed to provide operational feedback to a user.

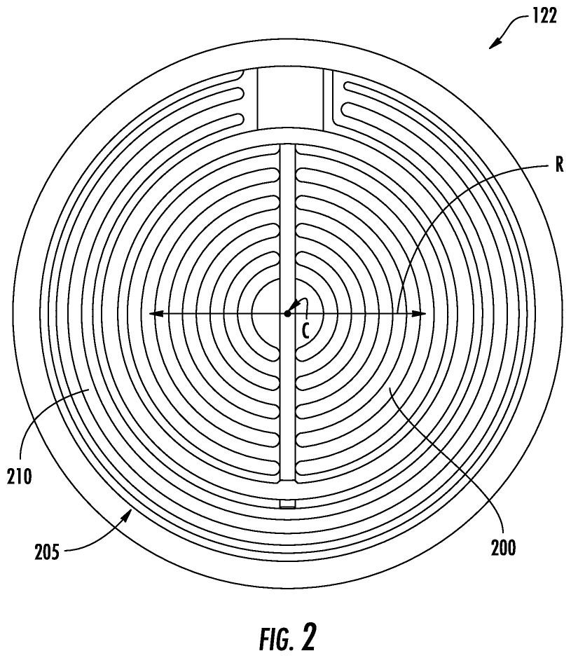

FIG. 2 provides a top, plan view of an exemplary heating assembly 122 for cooktop appliance 100 (FIG. 1). In various embodiments, heating assembly 122 includes a heating element 205. In an exemplary embodiment, such as depicted in FIG. 2, the heating element 205 may include a first or inner heating element 200 and a second or outer heating element 210. Outer heating element 210 of heating assembly 122 is positioned concentrically relative to inner heating element 200 of heating assembly 122. Inner heating element 200 of heating assembly 122 and outer heating element 210 of heating assembly 122 may be spaced apart from each other, e.g., along a radial direction R, such that outer heating element 210 of heating assembly 122 extends circumferentially around at least a portion of inner heating element 200 of heating assembly 122. It should be appreciated that the embodiment provided in FIG. 2 is provided by way of example only. Accordingly, various embodiments of the heating assembly may include a single heating element 205, or a plurality of two or more heating elements, or the heating assembly 122 may be configured as an induction heating assembly, or as a gas burner. Still further, cooktop appliance 100 (FIG. 1) may be configured with any combination of configurations of heating assembly 122.

FIG. 3 provides a schematic view of certain components of cooktop appliance 100. Cookware 300, such as a pot, pan, saucepan, skillet, kettle, griddle, or other cooking utensil, is positioned in thermodynamically communicative arrangement with the heating assembly 122. In various embodiments, cookware 300 positioned at the heating assembly 122 includes positioning the cookware 300 at the ceramic plate 110 such as to receive heat or thermal energy from the heating assembly 122. In a particular embodiment, the cookware 300 is positioned substantially concentrically to the heating element 122, although cookware 300 may be eccentric to the heating assembly 122. As described further herein, cookware 300 may be considered “removed” from the heating assembly 122 when the cookware is removed from substantial thermodynamic communication with the heating assembly 122.

Cookware 300 may include a body 302 defining a bottom cooking surface 310 and a handle 320 extending from the body 302. Cookware 300 is provided by way of example only, and it should be understood that any suitable piece of cookware may be used herein. Cookware 300 includes a temperature sensor 314. Sensor 314 may be positioned at or within cooking surface 310 or body 302. Cookware 300 may include a wired or wireless communication bus 316 configured to provide temperature signals to communication module 312. Cookware 300 may include communication module 312 provided within handle 320. Communication module 312 may selectively communicate with controller 140. For instance, communication module 312 may establish a wireless connection with controller 140 to provide one or more signals indicating a temperature of cookware 300. Moreover, communication module 312 may include a memory device configured to store certain information regarding cookware 300. Additionally, or alternatively, controller 140 may store information regarding multiple cookware items 300. However, in other embodiments, sensor 314 may be configured to provide wireless temperature signals directly to controller 140 without utilizing communication module 312.

As may be seen in FIG. 3, cooktop appliance 100 includes a controller 140. Operation of cooktop appliance 100 is regulated by controller 140. Controller 140 is operatively coupled or in communication with various components of cooktop appliance 100, including user interface 130. In response to user manipulation of the user interface 130, controller 140 operates the various components of cooktop appliance 100 to execute selected cycles and features.

Controller 140 may include a memory device 142, a processor 144, and a communications device 146. Memory device 142 is configured to receive or store instructions 143. Memory device 142 may be configured as a non-transitory memory device. Processor 144 may be configured as a general or special purpose microprocessor operable to execute programming instructions or micro-control code associated with a cooking cycle. The memory device 142 may represent random access memory such as DRAM, or read only memory such as ROM or FLASH. In one embodiment, the processor 144 executes programming instructions stored in memory, such as steps of one or more embodiments of the method provided herein. The memory device 142 may be a separate component from the processor 144 or may be included onboard within the processor 144. Alternatively, controller 140 may be constructed without using a processor, e.g., using a combination of discrete analog and/or digital logic circuitry (such as switches, amplifiers, integrators, comparators, flip-flops, AND gates, and the like) to perform control functionality instead of relying upon software. User interface 130, relay 230, heating assembly 122, sensor 314, or other components of cooktop appliance 100 and cookware 300 may be in communication with controller 140 via a wired or wireless communications bus 147, such as one or more signal lines or shared communication buses. In particular embodiments, controller 140 is configured to provide and terminate electrical power, gas flow, or other form of heating at the heating assembly 122 based on embodiments of the method provided herein.

Controller 140 is also in operative communication with heating assemblies 122 of cooktop appliance 100. As may be seen in FIG. 3, cooktop appliance 100 includes a relay 230. Relay 230 is coupled to heating assembly 122. Utilizing relay 230, controller 140 can selectively activate and deactivate heating assembly 122. Controller 140 may open and close relay 230 in response to temperature measurements from sensor 314, as discussed in greater detail below.

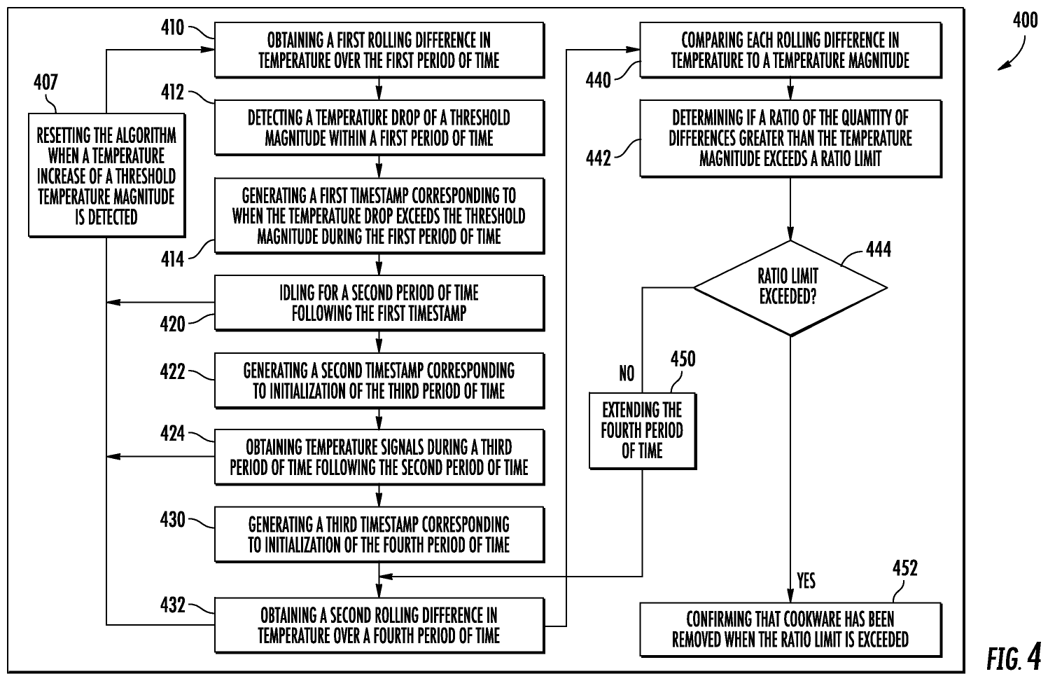

Referring now to FIG. 4, a flowchart outlining exemplary steps of a method for controlling a heating assembly of a cooktop appliance is provided (hereinafter, “method 400”). Steps of the method 400 may be stored in the memory device 142 at the controller 140 as steps or instructions 143 that, when executed by the processor 144, causes the cooktop appliance 100 to perform operations, such as one or more steps of the method 400. While the method 400 provided herein may be included in the controller 140 of embodiments of the cooktop appliance 100 such as provided herein, it should be appreciated that embodiments of the method 400 may be executed at other embodiments of a cooktop appliance, such as cooktop appliance having a radiant heating assembly, an induction heating assembly, a gas burner assembly, or combinations thereof.

Various embodiments of method may include monitoring, receiving, measuring, or otherwise obtaining a rolling temperature measurement. The rolling temperature measurement may include transmission and acquisition of temperature signals, such as from sensor 314 at cookware 300 to controller 140. Temperature signal acquisition may occur on a constant, rolling, or moving basis, such as from an initial time at which heat is turned on or otherwise activated, such as via user interface 130. The rolling basis at which temperature signals are obtained may occur at a suitable sample rate for cooktop appliances and cookware, or controllers, sensors, or other devices for cooktop appliances and cookware. In certain embodiments, obtaining the temperature signal may particularly occur during a closed-loop cooking cycle.

Method 400 includes at 412 detecting or determining a temperature drop of a threshold magnitude within a first period of time. Method 400 includes an observation period during which a temperature drop of, or greater than, a threshold magnitude is determined or detected. The observation period includes a first period of time forming a rolling time window during which a temperature drop of a threshold magnitude is detected or determined. Method 400 may particularly include at 410 obtaining a first rolling difference in temperature over the first period of time. In a particular embodiment, as rolling temperature measurements are obtained, changes in temperature during a rolling time window are monitored, such as provided at step 410, and determined whether there is a temperature drop of a threshold magnitude, such as provided at step 412. In certain embodiments, when the temperature drop at or greater than the threshold magnitude is detected, method 400 may include at 414 generating a first timestamp corresponding to when the temperature drop exceeds the threshold magnitude during the first period of time.

In an exemplary non-limiting embodiment, the first period of time forming the rolling time window is approximately 20 seconds and the threshold magnitude of the temperature drop is approximately 30 degrees Fahrenheit. Such temperature drop of the threshold magnitude occurring within the first period of time may indicate a cooking event. The cooking event may include adding food to the cookware (e.g., frozen or fresh food, water, liquid and/or solid food, meat, dairy, vegetables, etc.), fully removing the cookware from the heating assembly (e.g., cookware 300 removed from the heating assembly 122 or from the corresponding portion of the plate 110), or partially removing the cookware from the heating assembly (e.g., a portion of a cooking surface 310 removed from the heating assembly 122 or from the corresponding portion of the plate 110). The threshold magnitude is configured to be greater than normal fluctuations related to setting a temperature at the heating assembly. Normal fluctuations may occur during cooking or after a temperature overshoot.

Method 400 includes at 420 idling for a second period of time following the first time stamp. In various embodiments, method 400 at 420 idles for a second period of time following detection of the temperature drop exceeding the threshold magnitude. After determining when or whether the temperature drop of the threshold magnitude has occurred during the first period of time (i.e., a temperature drop at or greater than the threshold magnitude within the rolling time window of temperature signal acquisition), the method includes a wait period during which a temperature drop rate is allowed to decrease. The wait period includes the second period of time following the first period of time. In a particular embodiment, the second period of time is initialized when the first timestamp is generated. In an exemplary non-limiting embodiment, the second period of time is approximately 40 seconds, such as to allow the temperature drop rate to decrease. In a particular embodiment, method 400 at 420 may include discontinuing or pausing temperature signal acquisition, or reducing a sampling rate of temperature signal acquisition, during the second period of time, such as to reduce memory usage or processing at the controller. Method 400 may include at 407 resetting the algorithm when a temperature increase of a threshold temperature magnitude is detected. In particular embodiments, the temperature increase is measured with respect to a minimum recorded temperature value since the first timestamp.

Method 400 includes at 424 recording, acquiring, storing or otherwise obtaining temperature signals during a third period of time following the second period of time. During the wait period, method 400 includes obtaining temperature signals during the third period of time following the second period of time. In a particular embodiment, method 400 includes at 422 generating a second timestamp corresponding to initialization of the third period of time. In a still particular embodiment, method 400 at 422 includes continuing acquisition and recording of temperature signals, such as for utilization as described below. When a temperature increase of a threshold temperature magnitude is detected, method 400 may reset, such as provided at 407. In particular embodiments, the temperature increase is measured with respect to a minimum recorded temperature value since the first timestamp.

Method 400 includes at 432 obtaining a second rolling difference in temperature over a fourth period of time. After completing the wait period, method 400 includes a calculation period during which the rolling difference in temperature is obtained. The calculation period includes the fourth period of time following the third period of time. The rolling difference in temperature is a difference between a current temperature and a previous temperature at a predetermined amount of time before the current temperature. Method 400 obtains the rolling difference in temperature at a desired sample rate during the calculation period. In particular embodiments, method 400 includes at 430 generating a third timestamp corresponding to initialization of the fourth period of time. In certain embodiments, an initial rolling difference in temperature is between a temperature signal corresponding substantially to the third timestamp (e.g., current temperature) and a temperature signal corresponding substantially to the second timestamp (e.g., previous temperature). Temperature signals acquired during the third period of time form at least a portion of the predetermined amount of time before the current temperature at which rolling difference in temperatures are obtained. When a temperature increase of a threshold temperature magnitude is detected, method 400 may reset, such as provided at 407. In particular embodiments, the temperature increase is measured with respect to a minimum recorded temperature value since the first timestamp.

In an exemplary non-limiting embodiment, the calculation period includes the fourth period of time of approximately 60 seconds. In another exemplary embodiment, the predetermined amount of time is approximately 60 seconds. Stated differently, the predetermined amount of time may include the third period of time (i.e., approximately 60 seconds). In such an embodiment, the rolling difference in temperature is a difference between the current temperature and a temperature signal obtained 60 seconds prior to the current temperature (e.g., the previous temperature). In such an embodiment still, the rolling difference in temperature is between the current temperature during the fourth period of time and the previous temperature 60 seconds earlier. When the calculation period is 60 seconds and the sample rate is one (1) temperature signal per second, the calculation period obtains sixty (60) differences between a current temperature and a previous temperature (i.e., rolling difference in temperatures) during the calculation period. An initial temperature difference during the calculation period includes a temperature signal corresponding to a time after the third timestamp (e.g., corresponding to 1 second after the third timestamp, such as time=1 second at the fourth period of time) and a temperature signal corresponding to a time after the second timestamp (e.g., corresponding to 1 second after the second timestamp, such as time=1 second at the third period of time, or time=−59 seconds from the fourth period of time i.e., fifty-nine seconds prior to initializing the fourth period of time). The last temperature difference may correspond to a current temperature during the fourth period of time at time=60 seconds minus a previous temperature at time=0 seconds (i.e., a temperature signal corresponding to the third timestamp initializing the fourth period of time or corresponding to the end of the third period of time).

Method 400 includes determining, from the rolling difference in temperature, whether cookware is removed based on a comparison of the quantity of differences greater than a temperature magnitude to the quantity of differences less than the temperature magnitude. Method 400 may include at 440 comparing each rolling difference in temperature to a temperature magnitude. Method 400 at 440 may particularly include tabulating, recording, sorting, charting, or otherwise counting a quantity of differences greater than the temperature magnitude to a quantity of differences less than the temperature magnitude. In certain embodiments, the temperature magnitude is an absolute value. Method 400 at 440 may include determining (e.g., via tabulating, recording, sorting, charting, or otherwise counting) when each difference among the rolling difference in temperature is greater than or less than a temperature magnitude. In an embodiment, each instance may be categorized as either a “drop” or “no drop” or other appropriate designator.

In an exemplary non-limiting embodiment, the temperature magnitude is approximately 4 degrees Fahrenheit. The temperature magnitude may correspond to tolerances or fluctuations in temperature associated with closed-loop control of the heating assembly and the presence of the cookware at the cooktop appliance. For instance, decreases in temperature within the temperature magnitude (e.g., temperature decreases less than 4 degrees Fahrenheit) may be considered normal fluctuations or changes in temperature when cookware is present. Method 400 may count such instances as “no drop”. Decreases in temperature at or beyond the temperature magnitude (i.e., temperature decreases equal to or greater than 4 degrees Fahrenheit in this exemplary embodiment) may be indicative of cookware being removed. Method 400 may count such instances as “drop”. However, it should be appreciated that one skilled in the art may count occurrence of the temperature decrease equal to the temperature magnitude as “no drop” without substantially departing from the present subject matter.

Method 400 may include at 442 determining if a ratio of the quantity of differences greater than the temperature magnitude exceeds a ratio limit. Method 400 may include determining that the cookware is removed when a ratio of the quantity of differences greater than the temperature magnitude to the total quantity of differences exceeds a ratio limit. In an exemplary embodiment, when a ratio of “drop” to a total sum of “drop” and “no drop” is greater than or equal to a threshold (e.g., 50%), method 400 may determine that the cookware is removed. When the ratio is less than the threshold, method 400 may determine that the cookware is still at the heating assembly. In such an instance, method 400 may determine that changes in temperature are within normal fluctuations, such as may be associated with adding food to the cookware or partially removing the cookware from the heating assembly (e.g., placing off-center from the heating assembly).

Certain steps of method 400 may additionally mitigate potential false positives (i.e., false “cookware removed” outcomes), such as by including particular ranges of temperature drop, additional temperature thresholds, or both. Method 400 may include at 450 extending the calculation period, such as extending the fourth period of time over which the second rolling difference in temperature is obtained. Method 400 may include at 452 confirming that cookware has been removed when the ratio limit is exceeded. Certain embodiments of method 400 at 452 may include comparing a current temperature to a temperature threshold. In still particular embodiments, method 400 at 452 is performed following the method 400 at 442 or 440.

In a particular embodiment, method 400 includes at 454 iterating or extending the fourth period of time at which the rolling difference in temperature is obtained until the temperature threshold is exceeded. In a still particular embodiment, method 400 includes at 456 iterating or extending the fourth period of time at which the rolling difference in temperature is obtained until the cookware is determined to be removed from the heating assembly.

In an exemplary non-limiting embodiment, the temperature threshold is approximately 200 degrees Fahrenheit. In such an embodiment, when the current temperature during or following step 442 is less than approximately 200 degrees Fahrenheit, method 400 determines that the cookware has been removed from the heating assembly. In still such an embodiment, when the current temperature during or following step 442 is greater than or equal to approximately 200 degrees Fahrenheit and the temperature drop since the second timestamp is greater than or equal to 9 degrees Fahrenheit, method 400 determines that the cookware has been removed from the heating assembly. In still another instance, when the current temperature during or following step 442 is greater than or equal to approximately 200 degrees Fahrenheit and the temperature drop since the second timestamp is less than 9 degrees Fahrenheit, method 400 extends the calculation period, such as to extend the fourth period of time over which the second rolling difference in temperature is obtained.

In particular embodiments, method 400 includes at 460 reducing or eliminating energy input to the heating assembly when cookware removal is determined. Method 400 at 460 may include generating a signal from the controller to discontinue energy input to the heating assembly, or discontinuing power supply, or commanding a shut-off valve to discontinue gas flow, or any other appropriate method for discontinuing heat generation at the heating assembly.

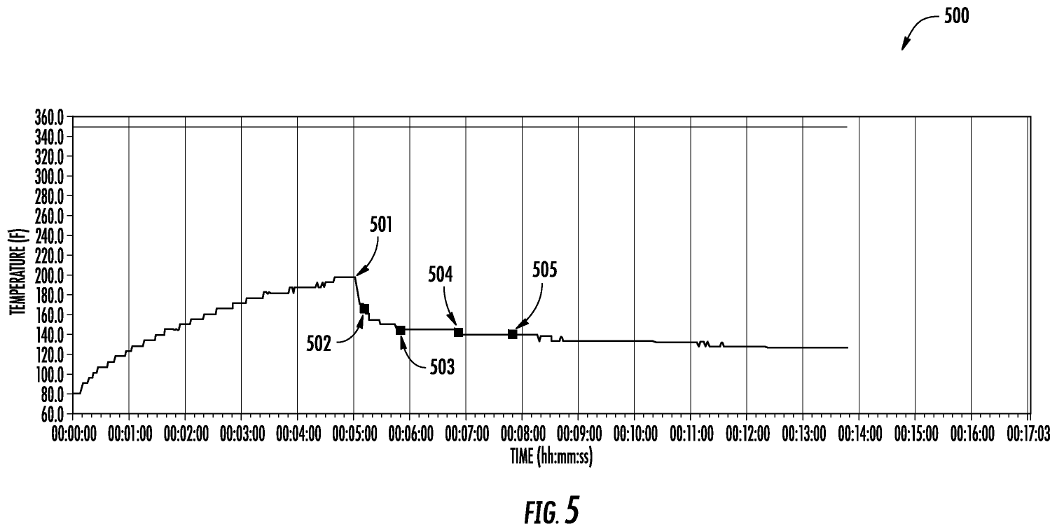

Referring now to FIG. 5, a graph 500 depicting an exemplary operation of the method 400 is provided. Graph 500 depicts a rise in temperature over time at a heating assembly from time zero. Acquisition of temperature signals occurs, such as from time zero. Rolling temperature measurements are obtained and changes in temperature during a rolling time window are monitored, such as provided at step 410. At 501, an event occurs resulting in temperature decrease. At 502, step 412 determines that a temperature drop of a threshold magnitude has occurred.

Method 400 at 414 may generate a first timestamp at 502 corresponding to when the first temperature threshold is exceeded. A wait period, such as the method 400 at step 420, begins from 502. From 502 to 503, the temperature is allowed to decrease during the second period of time. From 503 to 504, method 400 acquires temperature signals for a third period of time. In a particular embodiment, method 400 at 422 generates a second timestamp at 503 corresponding to initialization of the third period of time. Step 424 continues acquisition of temperature signals, such as through the third period of time beginning at 503.

Certain embodiments of method 400 may generate a third timestamp at 504, such as provided at step 430, corresponding to initialization of the calculation period. A second rolling difference in temperature is acquired over a fourth period of time, such as provided at step 432. Method 400 at 432 determines a difference between a current temperature and a previous temperature during a rolling time window. Particularly, an initial current temperature corresponds substantially to an initial period of time extending from the third timestamp, such as an acquisition time or a sample time, and an initial previous temperature corresponds to the second timestamp, such as an acquisition time or a sample time extending from the second timestamp. As used herein, the initial current temperature may correspond substantially to the third timestamp in contrast to subsequent temperature values following the initial current temperature. Still further, the initial previous temperature may correspond substantially to the second timestamp in contrast to subsequent temperature values following the initial previous temperature.

More particularly, an initial temperature difference is between an initial current temperature corresponding to a time after 504 (e.g., 1 second after 504) and an initial previous temperature corresponding to a time after 503 (e.g., 1 second after 503). Temperature differences are acquired during the rolling time window through the calculation period. The calculation period may extend through the fourth period of time corresponding to 504 to 505. A final temperature difference is between a final current temperature corresponding to 505 and a final previous temperature corresponding to 504. In certain embodiments, a continuous acquisition of temperature signals may start at 503. In certain embodiments, a continuous acquisition of temperature signals may stop during the second period of time during the waiting period, such as to minimize data acquisition, and resume from the third period of time.

Graph 500 depicts a continued decline in temperature from 503 onward. At 505, the calculation period may be terminated and the method 400 at 442 determines whether cookware was removed during the event at 501. Method 400 at 440, 442 may particularly count a quantity of temperature differences obtained during the calculation period and compare to a ratio limit to determine whether the event at 501 is associated with cookware removal. In regard to the embodiment of the method of operation depicted in graph 500, method 400 determines that the event at 501 was removal of the cookware.

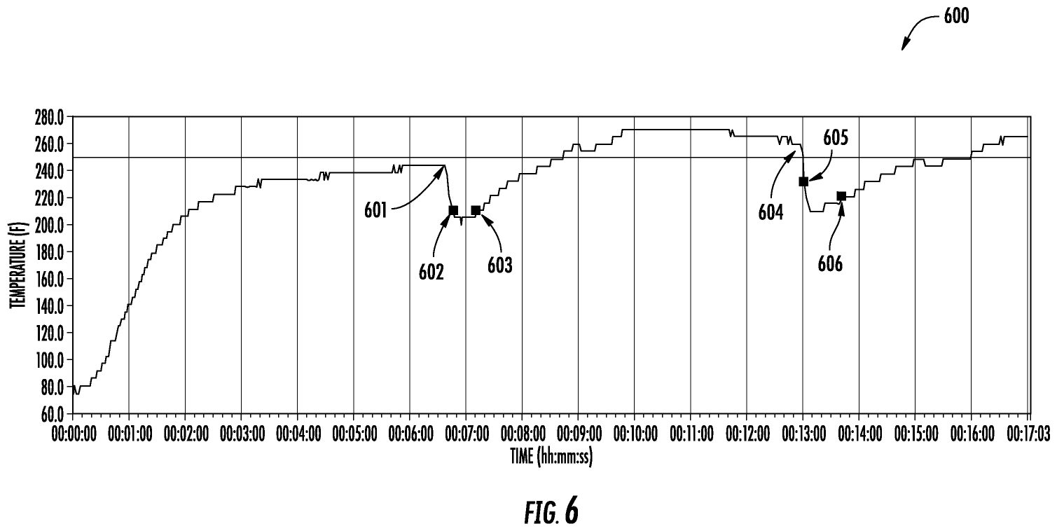

Referring now to FIG. 6, a graph 600 depicting an exemplary operation of the method 400 is provided. Graph 600 depicts a rise in temperature over time at a heating assembly from time zero, such as described in regard to graph 500. Acquisition of temperature signals occurs, such as from time zero. Rolling temperature measurements are obtained and changes in temperature during a rolling time window are monitored, such as provided at step 410. At 601, an event occurs resulting in temperature decrease. At 602, step 412 determines that a temperature drop of a threshold magnitude has occurred. Method 400 at 414 may generate a first timestamp at 602 corresponding to when the first temperature threshold is exceeded. A wait period, such as the method 400 at step 420, begins from 602. After 602, the temperature is allowed to decrease during the second period of time. At 603, method 400 at step 407 detects a temperature increase of a threshold magnitude.

In a particular embodiment, method 400 may include at step 407 determining or detecting a temperature increase greater than a temperature magnitude between the second timestamp (such as generated at step 422) and the first timestamp (such as generated at step 414). When the temperature increase is detected and the increase is greater than a predetermined temperature magnitude, method 400 may discontinue further steps and reset, such as provided at step 407, to obtain a rolling temperature measurement, such as at step 410. In the embodiment of operation depicted in FIG. 6, rather than a continuous temperature decrease after 602, the temperature increases relatively shortly after 602. In such an embodiment, method 400 may determine that a temperature increase is detected greater than the predetermined temperature magnitude, such as at 603. Method 400 may reset accordingly to obtaining a first rolling difference in temperature from 603 onward.

At 604, an event occurs resulting in temperature decrease. At 605, step 412 determines that a temperature drop of a threshold magnitude has occurred. Method 400 at 414 may generate a first timestamp at 605 corresponding to when the first temperature threshold is exceeded. A wait period, such as the method 400 at step 420, begins from 605. After 605, the temperature is allowed to decrease during the second period of time. At 606, method 400 at step 407 detects a temperature increase of a threshold magnitude. Method 400 may similarly reset at 606. In the particular embodiment depicted in FIG. 6, the event at 601 and 604 corresponds to food being added to the cookware. In various examples, FIG. 6 may be exemplary of foods from which a limited amount of liquid is released from the food to the cookware. Such exemplary foods may include eggs (e.g., fried eggs, omelets, egg white omelets, etc.).

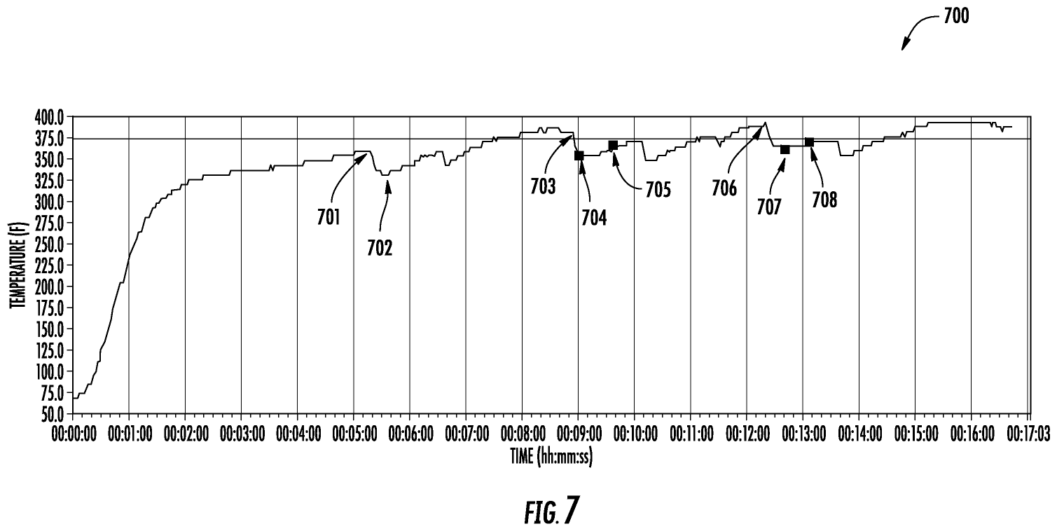

Referring now to FIG. 7, a graph 700 depicting an exemplary operation of the method 400 is provided. Graph 700 depicts a rise in temperature over time at a heating assembly from time zero, such as described in regard to graphs 500, 600. At 701, an event occurs resulting in a temperature drop. However, the temperature drop is insufficient to exceed the threshold magnitude to proceed to other steps of method 400. Accordingly, the difference in temperature between 701 and 702 may be determined to be a normal fluctuation in temperature. At 703, another event occurs and at 704 the temperature drop exceeds the threshold magnitude to proceed to other steps of method 400. However, at 705, the temperature rises beyond a temperature magnitude, such as at step 407. When the temperature exceeds the temperature magnitude, method 400 may reset, such as at 705. Similarly, the determination of cookware removal is repeated in regard to an event at 706 resulting in a temperature drop exceeding threshold magnitude at 707 and then exceeding the temperature magnitude at 708, such as to discontinue further steps of the method 400. In the particular embodiment depicted in FIG. 7, the event at 701, 703, and 706 corresponds to food being added to the cookware. In various examples, FIG. 7 may be exemplary of foods from which a limited amount of liquid is released to the cookware. Such exemplary foods may include meat or meat-alternatives (e.g., pork chops, lamb, beef, tofu, chicken, sausage, cutlets, etc.), vegetables (e.g., squash, Brussels sprouts, latkes, breaded vegetables, etc.), or pour-batter (e.g., pancakes, waffles, crepes, funnel cakes, etc.).

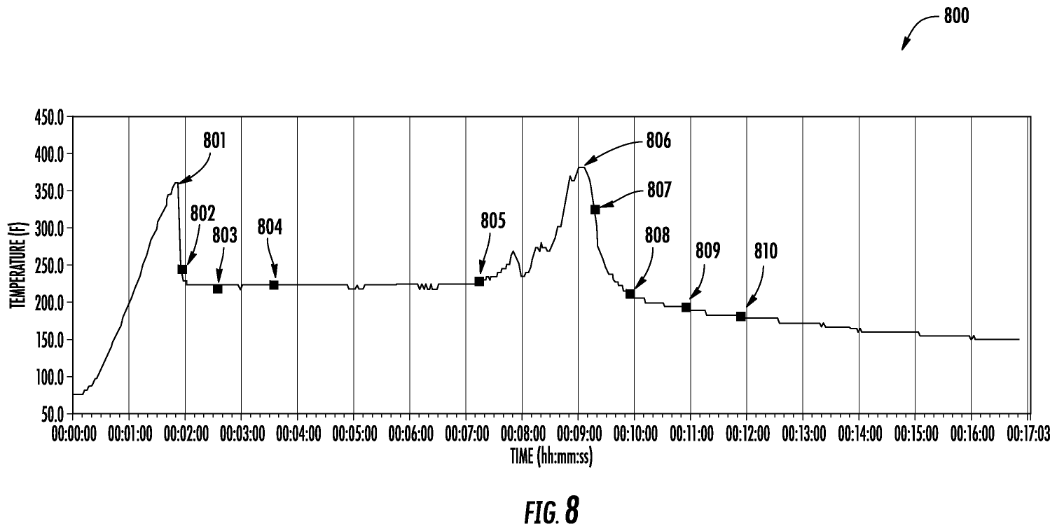

Referring now to FIG. 8, a graph 800 depicting an exemplary operation of the method 400 is provided. Graph 800 depicts a rise in temperature over time at a heating assembly from time zero, such as described in regard to graph 500, 600, 700. Acquisition of temperature signals occurs, such as from time zero. Rolling temperature measurements are obtained and changes in temperature during a rolling time window are monitored, such as provided at step 410. At 801, an event occurs resulting in temperature decrease. At 802, step 412 determines that a temperature drop of a threshold magnitude has occurred. Method 400 at 414 may generate a first timestamp at 802 corresponding to when the first temperature threshold is exceeded. A wait period, such as the method 400 at step 420, begins from 802. From 802 to 803, the temperature is allowed to decrease during the second period of time. In certain embodiments, the method has not determined that a temperature increase greater than temperature magnitude between the second timestamp 803 and the first timestamp 802 has occurred. Stated differently, acquired temperature signal indicate that the temperature has decreased from 802 to 803.

From 803 to 804, method 400 acquires temperature signals for a third period of time. In a particular embodiment, method 400 at 422 generates a second timestamp at 803 corresponding to initialization of the third period of time. Step 424 continues acquisition of temperature signals, such as through the third period of time beginning at 803.

Certain embodiments of method 400 may generate a third timestamp at 804, such as provided at step 430, corresponding to initialization of a fourth period of time corresponding to a calculation period. A second rolling difference in temperature is acquired over the fourth period of time, such as provided at step 432. Method 400 at 432 determines a difference between a current temperature and a previous temperature during a rolling time window, such as described in regard to FIG. 5.

In a particular embodiment, the calculation period is extended, such as provided at step 450. As depicted in FIG. 8, between 804 and 805, the temperature remains substantially unchanged. Step 440 may count variations in temperature as “no drop” for being less than the predetermined temperature magnitude. In various embodiments, method 400 may reset following the calculation period if cookware removal is detected, or if temperature increase is detected greater than a temperature magnitude, such as at 805, or if a timeout period is predetermined.

Graph 800 depicts a rise in temperature from 805 onward. At 806, a second event occurs resulting in temperature decrease. At 807, step 412 determines that a temperature drop of a threshold magnitude has occurred. Method 400 at 414 may generate a first timestamp at 807 corresponding to when the first temperature threshold is exceeded. A wait period, such as the method 400 at step 420, begins from 807. From 807 to 808, the temperature is allowed to decrease during the second period of time. From 808 to 809, method 400 acquires temperature signals for a third period of time. In a particular embodiment, method 400 at 422 generates a second timestamp at 808 corresponding to initialization of the third period of time. Step 424 continues acquisition of temperature signals, such as through the third period of time beginning at 808.

Certain embodiments of method 400 may generate a third timestamp at 809, such as provided at step 430, corresponding to initialization of the calculation period. A second rolling difference in temperature is acquired over a fourth period of time, such as provided at step 432. Method 400 at 432 determines a difference between a current temperature and a previous temperature during a rolling time window. More particularly, an initial temperature difference is between an initial current temperature corresponding to a time after 809 (e.g., 1 second after 809) and an initial previous temperature corresponding to a time after 808 (e.g., 1 second after 808). Temperature differences are acquired during the rolling time window through the calculation period. The calculation period may extend through the fourth period of time corresponding to 809 to 810. A final temperature difference is between a final current temperature corresponding to 810 and a final previous temperature corresponding to 809. In certain embodiments, a continuous acquisition of temperature signals may start at 808. In certain embodiments, a continuous acquisition of temperature signals may stop during the second period of time during the waiting period, such as to minimize data acquisition, and resume from the third period of time.

Graph 800 depicts a continued decline in temperature from 810 onward. At 810, the calculation period may be terminated and the method 400 at 442 determines whether cookware was removed during the event at 806. Method 400 at 440, 442 may particularly count a quantity of temperature differences obtained during the calculation period and compare to a ratio limit to determine whether the event at 806 is associated with cookware removal. In regard to the embodiment of the method of operation depicted in graph 800, method 400 determines that the event at 806 was removal of the cookware. In the embodiment depicted in FIG. 8, the event at 801 may particularly correspond to frozen food or food from which a relatively large amount of liquid is released and added to the cookware, resulting in an initial temperature decrease from 801 followed by a period of temperature stabilization.

Embodiments of a method for operating a cooktop appliance are provided herein that allow for determining whether cookware has been removed from a heating assembly. Particular embodiments of method 400 may provide accurate and consistent detection of cookware removal and may mitigate false positives or false negatives. In certain embodiments, method 400 may determine within a desired amount of time (e.g., within 180 seconds of an event) whether cookware has been removed from the heating assembly. Method 400 may furthermore distinguish the event from one or more other non-removal events, such as adding liquid and/or solid food to the cookware, partial cookware removal from the heating assembly, or spilling fluids onto the heating assembly. Detection and determination of cookware removal may mitigate damage to cookware, cooktop appliances, surrounding kitchen or housing structures, smoke damage, accidental burns, or other adverse outcomes. Various embodiments of method 400 may include reducing or terminating power to the heating assembly following determination of cookware removal from the cooktop appliance.

It should be appreciated that while particular exemplary embodiments are provided herein utilizing specific quantities of temperatures, magnitudes, periods of time, thresholds, or limits, persons skilled in the art may adjust, modify, change, or otherwise alter one or more such quantities without deviating from the scope of the present disclosure. Certain embodiments including certain quantities may be provided by example. Still particular embodiments may include certain quantities having particular novel limits, ranges, thresholds, or temperatures providing desired benefits not otherwise previously disclosed in the art.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computer-implemented method for controlling a heating assembly of a cooktop appliance, the method comprising:
detecting a temperature drop of a threshold magnitude during an observation period;
allowing for temperature decrease during a waiting period;
obtaining a rolling difference in temperature during a calculation period; and
determining, from the rolling difference in temperature, whether cookware is removed based on a comparison of a quantity of differences above a temperature magnitude to a quantity of differences below the temperature magnitude.

2. The computer-implemented method of claim 1, the method comprising:
determining that cookware is removed from the heating assembly when a ratio of the quantity of differences above the temperature magnitude to the quantity of differences below the temperature magnitude exceeds a ratio limit.

3. The computer-implemented method of claim 1, wherein determining whether cookware is removed comprises:
tabulating each difference between a current temperature and a previous temperature over a rolling basis through the fourth period of time; and
comparing the current temperature to a temperature threshold.

4. The computer-implemented method of claim 1, wherein detecting the temperature drop of the threshold magnitude during the observation period comprises:
obtaining a first rolling difference in temperature over a first period of time.

5. The computer-implemented method of claim 1, wherein the observation period comprises a first period of time forming a rolling time window during which the temperature drop of the threshold magnitude is detected.

6. The computer-implemented method of claim 5, wherein the wait period comprises:
idling for a second period of time following detection of the temperature drop exceeding the threshold magnitude; and
obtaining temperature signals during a third period of time following the second period of time.

7. The computer-implemented method of claim 6, the method comprising:
generating a first timestamp corresponding to when the temperature drop exceeds the threshold magnitude; and
generating a second timestamp corresponding to initialization of the third period of time.

8. The computer-implemented method of claim 7, the method comprising:
determining a temperature decrease greater than a temperature magnitude between the second timestamp and the first timestamp.

9. The computer-implemented method of claim 7, the method comprising:
generating a third timestamp corresponding to initialization of a fourth period of time, wherein the fourth period of time corresponds to the calculation period.

10. The computer-implemented method of claim 9, wherein obtaining the rolling difference in temperature during the calculation period comprises a difference between a current temperature and a previous temperature at a predetermined amount of time before the current temperature.

11. The computer-implemented method of claim 10, wherein an initial current temperature corresponds substantially to the third timestamp and an initial previous temperature corresponds substantially to the second timestamp.

12. The computer-implemented method of claim 1, the method comprising:
generating, when cookware is determined to be removed, a signal corresponding to decreasing or terminating an energy input to the heating assembly.

13. A cooktop appliance, comprising:
a heating assembly; and
a controller in operative communication with the heating assembly, the controller configured to:
detect a temperature drop of a threshold magnitude within a first period of time;
after a second period of time from detection of the temperature drop of the threshold magnitude, obtain a temperature signal during a third period of time;
obtain a rolling difference in temperature over a fourth period of time following the third period of time; and
determine, from the rolling difference in temperature, whether cookware is removed based on a comparison of a quantity of differences above a temperature magnitude to a quantity of differences below the temperature magnitude.

14. The cooktop appliance of claim 13, the controller configured to:
reduce or terminate an energy input to the heating assembly based on whether cookware is determined to be removed.

15. The cooktop appliance of claim 12, the controller configured to:
determine that cookware is removed from the heating assembly when a ratio of the quantity of differences above the temperature magnitude to the quantity of differences below the temperature magnitude exceeds a ratio limit.

16. The cooktop appliance of claim 12, wherein determining whether cookware is removed comprises:
tabulating each difference between a current temperature and a previous temperature over a rolling basis through the fourth period of time; and
comparing the current temperature to a temperature threshold.

17. The cooktop appliance of claim 12, the controller configured to:
obtain a first rolling difference in temperature over the first period of time.

18. The cooktop appliance of claim 12, the controller configured to:
generate a first timestamp corresponding to when the temperature drop exceeds the threshold magnitude;
generate a second timestamp corresponding to initialization of the third period of time; and
generate a third timestamp corresponding to initialization of the fourth period of time.

19. The cooktop appliance of claim 18, the controller configured to:
determine a temperature decrease greater than a temperature magnitude between the second timestamp and the first timestamp.

20. The cooktop appliance of claim 18, the controller configured to:
obtain the rolling difference in temperature during the fourth period of time comprising a difference between a current temperature and a previous temperature, wherein an initial current temperature corresponds substantially to the third timestamp and an initial previous temperature corresponds substantially to the second timestamp.
